(19) United States
(12) Patent Application Publication
(10) Pub. No.: US 2010/0030384 A1
(43) Pub. Date: Feb. 4, 2010

(54) Vibration Isolation System With Design For Offloading Payload Forces Acting on Actuator

(75) Inventors: Emil Kraner, Newton, MA (US); Ulf Heide, Marblehead, MA (US); Tony Lopes, Salem, MA (US)

Correspondence Address: GREENBERG TRAURIG, LLP, ONE INTERNATIONAL PLACE, 20th FL, ATTN: PATENT ADMINISTRATOR, BOSTON, MA, 02110, US

(73) Assignee: Technical Manufacturing Corporation

(21) Appl. No.: 12/181,846

(22) Filed: Jul. 29, 2008

(51) Int. Cl. G05B 21/00; F16F 7/10

(52) U.S. Cl. 700/280; 188/380

(57) ABSTRACT

An active damping system for use in connection with a vibration isolation system is provided. The active damping system having an actuator for placement on the ground, and an intermediate mass supported on the actuator for acting as a stability point to which dynamic forces can be dampened and isolated from the payload. The active damping system also includes a passive damping element and a support spring, both coupled at one end to a payload and at an opposite end to the intermediate mass. At least one offload spring can be situated between the intermediate mass and the ground for partially supporting any weight from the payload acting on the actuator. A sensor can also be affixed to the intermediate mass to generate a feedback signal to the actuator for subsequent acting on the intermediate mass to permit the intermediate mass to act as a stability point. A system and method for isolating dynamic forces using such an active damper is also provided.

### TECHNICAL FIELD

The present invention relates generally to systems and methods for isolating vibration from a supported payload, and more particularly, to systems and methods for offloading of supported payload forces acting on an actuator in vibration isolation.

### BACKGROUND ART

The need in industry for vibration isolation has been growing with the increase in the precision and use of precision devices and equipments. As a result, the need to suppress and isolate dynamic forces, such as environmental or external vibration, has increased, with less and less tolerance for such forces acting on these precision devices. For example, as minimum feature sizes continue to shrink in connection with the manufacturing of semiconductors, in order to carry out these manufacturing processes with unprecedented complexity while maintaining extreme precision, the importance of providing a substantially vibration-free environment within which equipment such as ultraviolet steppers, semiconductor aligners, and other equipments can operate during the manufacturing process has become important and clear.

Active dampers, such as voice coil dampers or motor elements have been used to address vibration. In particular, these active dampers may be used to produce relatively high compensation forces, and along with sensors positioned on the isolated payload, can compensate for the forces generated by the heavy payload moved with high acceleration. However, active dampers also have very limited active bandwidth gain. In particular, the coupling of payload resonances with sensed outputs can compromise stability margins. This limitation may be due to the servo loop stability that can be limited by the required attachment of vibration sensors to the isolated platform sensing its multiple resonances.

For the semiconductor manufacturing industry, in addition to the demand for decreasing minimum size feature, there has been an increase in the overall size of the wafers being manufactured to meet current needs. For instance, the size of the wafers being made is now about 300 mm to 450 mm. To accommodate the manufacturing of these bigger wafers, bigger and heavier equipments, such as moving stages, wafer loaders, etc, must be utilized. With these bigger and heavier equipments, dynamic forces generated by movement of their components, and the resulting vibration can also significantly increase.

To suppress and isolate the vibration generated by these bigger and heavier equipments to an acceptable tolerance level, displacement devices, such an actuator, must not only be able to support the heavier equipment, but must also be capable of generating sufficient displacement to compensate for the forces acting on the equipment, so that vibration can be suppressed to an acceptable level. An actuator, in general, is a device designed to perform actuating function of a load fixed to one of its interfaces. These functions comprise movement, positioning, and/or stabilizing of the supported payload. Actuation of the payload may be performed by means of two actuating points to which mechanical interfaces of the actuator correspond and which define the actuating axis. One of the actuating point may be fixed to the payload, whereas the other point may be fixed to a base acting as a mechanical mass to counteract the reaction forces. Actuation generally takes place along at least one direction called the actuating direction, corresponding to a degree of freedom of the actuator, and is performed by deformation of the actuator between the two actuating points.

The use of bigger and more powerful actuators that not only can support the bigger and heavier equipments (i.e., payload), but also can also suppress and isolate the vibration generated to an acceptable tolerance level can be expensive and cost prohibitive.

In certain instances, to lessen the weight (i.e., the static force) of the supported payload acting on the actuator, certain vibration isolation systems have employed the use of a support spring. In general, such a support spring is positioned in parallel to the active damper system, of which the actuator is a component, and extends from the supported payload to the ground to offload the weight of the payload that would otherwise be acting on the actuator. Examples of vibration isolation systems that employ such a support spring can be seen in U.S. Publication No. 2007/0273074 and U.S. Pat. No. 6,752,250. However, the existence of such a support spring, while lessening the weight of the supported payload on the actuator, can actually compromise the efficiency of the vibration isolation system. In particular, since the support spring extends from the ground to the payload, any external or ground vibration can be transferred to the payload, and thus compromise the vibration isolation process of the active damper system.

Accordingly, it is desirable to provide a vibration isolation system that can lessen weight from the supported payload acting thereon (i.e., offload weight from the supported payload), and that can actively isolate vibration, whether external, from the environment, or from the components of the vibration isolation system, in a cost effective and efficient manner, without compromising the vibration isolation process.

### SUMMARY OF THE INVENTION

The present invention provides an active vibration damping system that can offload the static force (i.e., weight) from the supported payload acting on the actuator, while damping and actively suppressing range of dynamic forces over a wide frequency bandwidth, that can act on the payload, without compromising system performance. By being able to offload the weight from the supported payload, the system of the present invention can utilize a relatively smaller actuator to support a substantially similar size payload without compromising the vibration isolation process. Alternatively, a substantially similar size actuator can be used to support a bigger payload without compromising isolation of the dynamic forces acting thereon.

The vibration damping system, in one embodiment, includes an actively isolated damper positioned between the payload mass, such as an isolated platform, and a source of vibration or dynamic forces, such as the ground, floor, external casing, or a vibrating base platform, in order to dampen and isolate the dynamic forces from the payload. The actively isolating damper (“active damping system”), in an embodiment, includes an actuator for placement on the ground, floor, external casing, or base platform. The actuator, by design, can be used to compensate for dynamic forces acting on the system. The active damper can also include an intermediate mass supported on the actuator assembly for providing a stability point to which dynamic forces can be dampened and isolated from the payload. In one embodiment, the intermediate mass may be distinct and elastically decoupled from the payload. The active damper further includes a passive damping element coupled at one end to the payload and at an opposite end to the intermediate mass, which by design acts as a stability point to which dynamic forces can be dampened. In an embodiment, the passive damping element can act to direct dynamic forces from the payload to the stability point where such forces can be dampened. In addition, at least one offload spring can be situated between the intermediate mass and the ground to permit weight from the payload acting on the actuator to be transferred thereonto. In particular, the offload spring can act to partially support the payload weight acting on the actuator. A sensor can also be affixed to the intermediate mass to generate a feedback signal to the actuator for subsequent generation of a stability point on the intermediate mass. A module containing various compensation circuits can also be provided to integrate the signal from the sensor, so as to allow the actuator to generate a stability point on the intermediate mass.

In another embodiment, an active damping system for use in connection with an vibration isolation system is provided. The active damping system includes an actuator for placement with one end on the ground, floor, external casing, or base platform, and with the other end coupled to the intermediate mass, which by design acts as a stability point. The actuator, in one embodiment, includes can be an amplified actuator designed to increase stroke applied to the payload in the presence of proportionately a reduced applied force. The active damping system also includes a passive damping element coupled at one end to a payload and at an opposite end to the intermediate mass, so as to stabilize the supported payload from dynamic forces. At least one offload spring can be situated between the intermediate mass and the ground for partially supporting any weight from the payload acting on the actuator assembly. A sensor can also be affixed to the intermediate mass to generate a feedback signal to the actuator assembly for subsequent generation of a stability point on the intermediate mass. A support spring may also be provided between the payload and the intermediate mass in parallel to the passive damping element, in order to support the weight of the payload. The support spring, along with the passive damping element can act to elastically decouple supported payload from the intermediate mass.

In a further embodiment, a method for isolating vibration from a payload supported on an isolated platform is provided. The method includes initially positioning an actuator on a base platform or on the ground under an isolated platform designed to support a payload. Next, an intermediate mass may be placed on the actuator assembly, so as to permit subsequent generation of a stability point on the intermediate. The stability point, in an embodiment, can permit vibration and other dynamic forces to be directed thereto, in order to dampen and isolate such vibration and other dynamic forces from a payload. The intermediate mass can also be designed to be distinct and elastically decoupled from the payload. After the intermediate mass is in place, at least one offload spring may be situated under the intermediate mass and on the base platform. The presence of the offload spring can permit partial support thereon of any weight from the payload acting on the actuator assembly. Thereafter, one end of a passive damper can be coupled to the isolated platform and an opposite end coupled to an area where the stability point can be generated on the intermediate mass. A support spring may also be provided in parallel with the passive damper between the payload and the intermediate mass, in order to stabilize the supported payload. Once the components are in place, movement of the intermediate mass resulting from dynamic forces being directed thereto by the various components can be sensed, and a feedback signal that is a function of the movement of the intermediate mass can be generated. The actuator may be then permitted, based the feedback signal, to vary in length, so as to generate and maintain the intermediate mass as a stability point to which dynamic forces the can be dampened and isolated from the payload.

### BRIEF DESCRIPTION OF DRAWINGS

FIG. 1 illustrates a system for active vibration isolation and damping, in accordance with one embodiment of the present invention.

FIG. 2A illustrates a schematic diagram of an active damping system for use in connection with the system in FIG. 1.

FIG. 2B illustrates an isometric view of a portion of the active damping system shown in FIG. 2A.

FIG. 3 illustrates an active damping system for active vibration isolation and damping, in accordance with another embodiment of the present invention.

FIG. 4 illustrates a system for active vibration isolation and damping, in accordance with another embodiment of the present invention.

FIG. 5 is an electrical schematic block diagram illustrating the electrical interconnections between motion sensors, compensation circuitry and actuators for a three-dimensional vibration isolation or damping system.

FIG. 6 illustrates a simplified schematic diagram of an active vibration damping system along two axes.

### DESCRIPTION OF SPECIFIC EMBODIMENTS

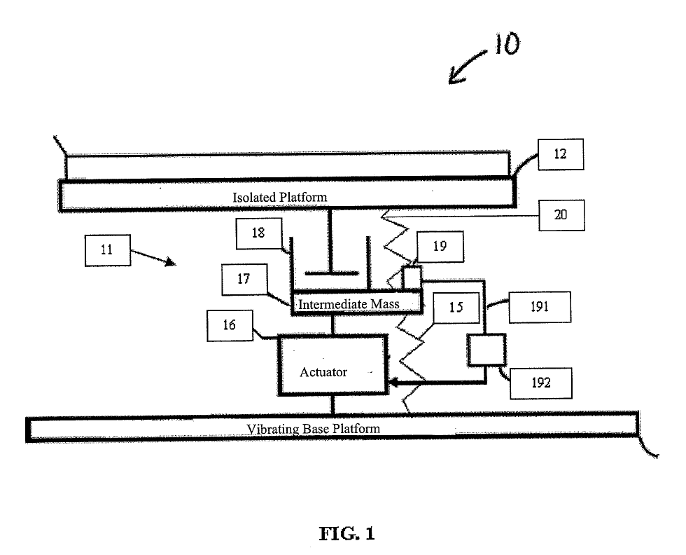

FIG. 1 illustrates an active vibration isolation system 10, in accordance with one embodiment of the present invention. System 10, in an embodiment, includes an active damping system 11 positioned between (i) an isolated payload 12 (i.e., isolated platform and payload supported thereon), and (ii) a source of vibration, such as the floor, external casing, or a vibrating base platform 14, to suppress and isolate vibration and other dynamic forces from being transmitted to the payload 12. System 10 may also include, coupled to the active damping system 11, a mechanism 15 designed to offload the weight exerted by the supported payload 12 that otherwise would directly act on components of the active damping system 11. It should be appreciated that FIG. 1 illustrates a system which addresses active or dynamic vibration isolation in one of three dimensions. This simplification has been made for the ease of explanation. However, it should be understood that system 10 is capable of being utilized to permit active vibration isolation up to all six degrees of freedom.

The active damping system 11, positioned between the isolated platform 12 and a source of vibration or dynamic forces, such as the ground, floor, external casing, or a vibrating base platform 14, and which can act to dampen and isolate dynamic forces from the payload 12, in an embodiment, includes an actuator 16 that may be coupled to the base platform 14, a small intermediate mass 17 (“intermediate mass”) supported on the actuator 16, along with a passive damping element 18 and support spring 20 situated between the payload 12 and the intermediate mass 17 for supporting the static forces (i.e., weight) of payload 12, as well as damping dynamic forces (i.e., vibration) from payload 12. Active damping system 11 may also include a motion sensor 19 attached to the intermediate mass 17, such that signals generated from motion of the intermediate mass 17 can be compensated as part of an active feedback compensation loop 191 to provide stability to the intermediate mass 17 over a predetermined range of vibration frequencies.

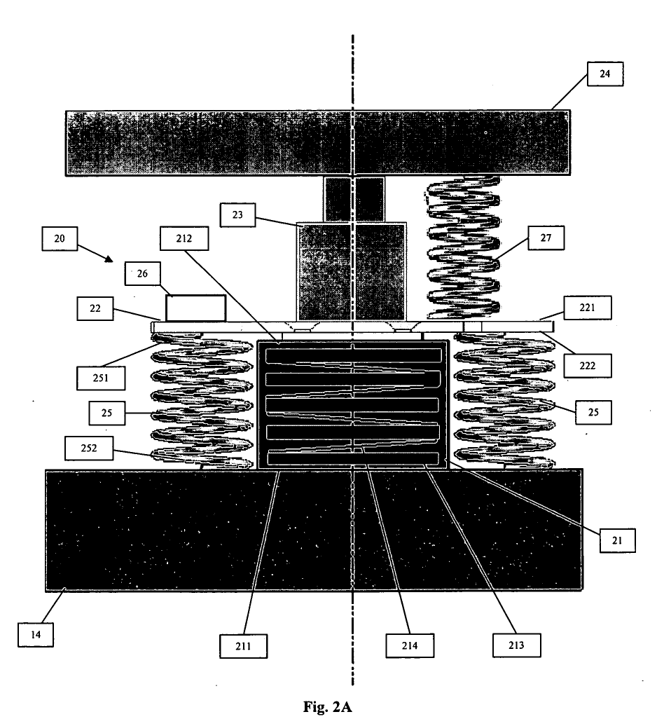

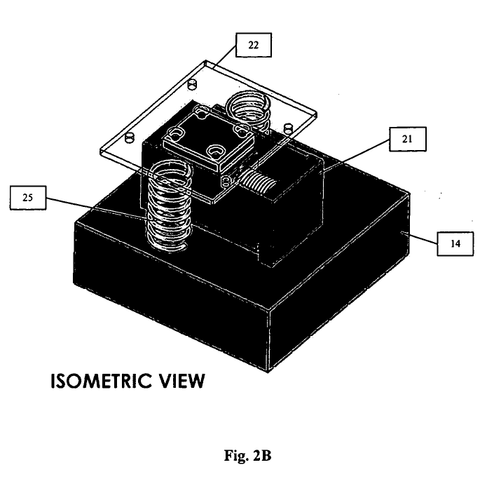

With reference now to FIGS. 2A-B, there is shown, in one embodiment, an active damping system 20 for use in connection with system 10 of the present invention. Active damping system 20, like active damping system 11 in FIG. 1, can be used, in one aspect, to isolate and dampen vibration and other dynamic forces, created by external forces or components of system 10, from being transferred to the payload 12. The active damping system 20, as illustrated, includes an actuator 21, positioned on a base platform or ground 14, an intermediate mass 22 supported on the actuator 21 and acting as a stability point (i.e., vibration-free point) to which dynamic forces can be dampened by way of a passive damping element 23 (“passive damper”), and to which static forces can also be applied through support spring 27. As shown, both the passive damping element 23 and support spring 27, in one embodiment, can be coupled at one end to payload 24 (i.e., isolated platform and a payload supported thereon) and at an opposite end to the intermediate mass 22 acting as the stability point. The active damping system 20 can also include at least one offload spring 25 situated between the intermediate mass 22 and ground 14 (or base platform) for partially supporting any weight from payload 24 acting on the actuator 21, and a sensor 26 affixed to the intermediate mass 22 to generate a signal, which is a function of movement of the intermediate mass 22, so feedback can be provided to the actuator 21 for subsequent generation of a stability point on the intermediate mass 22.

Actuator 21, in an embodiment, includes a bottom end 211 attached to vibrating base platform or ground 14. The actuator 21 also includes a top end 212, which can remain substantially motionless or approximately so, with the objective of minimizing motion to, for instance, 0.01 times the movement of base platform or ground 14. The active damping system 20 of the present invention, in connection with actuator 21, may be designed to isolate vibration of the base platform or ground 14 along axis Z, which is substantially parallel to the axis of displacement of actuator 21, from the payload.

In one embodiment of the invention, the actuator 21 may be a piezoelectric stack. In such an embodiment, the actuator 21 may include a first substantially rigid element, e.g., a stack 213, having a length along axis Z, and which may be variable as a function of a control signal applied thereto. In one embodiment of the present invention, actuator 21 may be designed to include a maximum relative stack displacement of about 0.001 to about 0.005 inches peak.

As a piezoelectric stack, actuator 21 may be modeled as a motor spring 214 with sufficient stiffness. The stiffness of the spring 214 along its axis allows the actuator 21 to contract or elongate readily according to a command signal applied thereto and independently from the weight (i.e., static force) of payload 24. The stiffness of the spring 214, in one embodiment, may be at least one order of magnitude higher in stiffness than that of offload spring 25, and preferably at least two orders of magnitude higher in stiffness. In an example, the stiffness of spring 214 may be about 1.9 million pounds per inch, whereas the displacement-to-voltage relationship may be about 1 million volts per inch peak.

With certain types of piezo actuators, especially those which generate force only in one direction, it may be necessary to preload the actuator 21, such that under actual operation, the actuator 21 may be prevented from going into tension, and that a “return” force can be applied. Spring 214, therefore, may be used to preload the actuator 21. In an embodiment, spring 214 may be a steel spring and may be used to provide a preload compression that is measurable greater than the dynamic forces generated on the payload 24 along a compression axis, for instance, axis Z. The spring 214 may be preloaded by the use of a compression set screw or other means (not shown) to provide the required pound thrust force in the compression direction.

Although illustrated as a piezoelectric actuator, it should be appreciated that actuator 21 may be any actuator, so long as such an actuator can by used in connection with the active damping system 20. For instance, any mechanical, electrical, pneumatic, hydraulic, or electromagnetic actuators, or any other actuators commercially available or known in the industry can be used. In certain instances it may be desirable to increase the stroke of such an actuator being applied to the payload, especially when less force can be applied by or to the less powerful actuator. Also, where an actuator less powerful relative to one that must both support the mass of the payload 24 and address dynamic forces is used, the use of the less powerful actuator can reduce overall costs to the system 10. To that end, an amplified actuator, similar to actuator 21 shown in FIG. 2B, may be used. Such an amplified actuator, depending on the application, can be adapted to provide more stroke in the presence of less load, or less stroke in the presence of more load, if so desired.

In one example, if the supported payload Mₚ were supported directly by the actuator 21, the payload resonance frequency may be approximately 130 cycles per second, if the payload mass Mₚ is, for instance, about 1000 pounds in weight. Such a resonance frequency can lead to reduction of vibration isolation gain. The desired gain may be difficult or impossible to obtain at frequencies near that of the payload resonance frequency, which in this case, may be 130 cycles per second. In addition, without correction, the system amplifies vibration greatly at the payload resonance frequency, and most of the benefit of the vibration isolation may be lost.

To address this issue, the active damping system 20 may be provided with an intermediate mass 22, positioned between the actuator 21 and the supported payload 24. The intermediate 22, in an embodiment, may be elastically decoupled from the payload 24, by way of support spring 27 and passive damper 23, to act as an actively isolating point (i.e., vibration-free point) to which dynamic forces may be dampened, so that dynamic forces from ground 14 or other components of the system 10 can be isolated from being transferred to the payload 24. In one embodiment, the intermediate mass 22 may have a mass value of Mₛ, which can be at least one order of magnitude or more (e.g., two orders of magnitude) smaller than the range of masses that the system 10 may be designed to support or isolate, Mₚ. The intermediate mass 22, as illustrated in FIG. 2A, may be a substantially flat body having an upper surface 221 and a bottom surface 222. The intermediate mass 22 may be positioned with its bottom surface 222 directly on the top end 212 of actuator 21. In certain instances, it may be desirable to secure the position of the intermediate mass 22 over the actuator 21, so as to minimize lateral or radial movement of the intermediate mass 22. To that end, any mechanisms known in the art may be used to substantially secure intermediate mass 22 to actuator 21, and to minimize lateral or radial movement of the intermediate mass 22.

It should be noted that since actuator 21, in an embodiment of the invention, isolates vibration and other dynamic forces created by components of the system 10 or by ground 14 from being transferred to the payload 24, while must simultaneously address the static forces generated by the mass (i.e., weight) of the payload 24, in order to lessen the mass of the payload 24 that may be applied to the actuator 21, offload springs 25 may be provided. As illustrated in FIG. 2A, offload springs 25, in one embodiment, may be positioned under intermediate mass 22 and on each side of actuator 21, such that top end 251 of each offload spring 25 may be coupled to the intermediate mass 22, while bottom end 252 of each offload spring 25 may be positioned on ground 14. The existence of offload springs 25 permit weight from the payload 24 acting on the actuator 21 to be transferred onto the offload springs. In other words, the offload spring 25 can act to partially support any weight from the payload 24 acting on the actuator 21.

Although shown with two offload springs 25, the present invention, of course, contemplates using one or more offload springs 25, if so desired. For example, if only one offload spring 25 is used, such an offload spring may be positioned circumferentially about actuator 21 under the intermediate mass 22. However, three or more offload springs 25 may be used, these offload springs may be situated in any manner that can permit weight from payload 24 to be sufficiently transferred thereonto. Of course, springs 25 may be positioned anywhere adjacent actuator 21, so long as such a spring or springs may be situated under intermediate mass 22.

Offload springs 25, in an embodiment, may be metallic springs, coil springs, die springs, or any other similar springs. Moreover, since offload springs 25 may be provided in order to lessen the weight of the payload 24 that may be applied to the actuator 21, offload springs 25 may not need to be as substantially stiff or rigid as rigid element of actuator 213. In an embodiment, offload springs 25 may be at least one order of magnitude less in stiffness than that exhibited by actuator 21.

It should be appreciated that the presence of offload spring or springs 25 can permit partial support of any weight from payload 24 that may otherwise act on the actuator 21. As such, the presence of offload spring or springs 245 can permit active damping system 20 to employ one or fewer actuators 21 then would otherwise be needed to sufficiently achieve the necessary damping activity, even if the mass of the payload 24 increases. Moreover, an actuator less expensive and less powerful relative to one that must support the mass of the payload 24, as well as addressing the dynamic forces may be used. Of course, if an actuator equally as powerful as the one that must support the mass of the payload 24, while addressing the dynamic forces is used, such additional power from the amplified actuator can be used to support a substantially heavier load, for example at least two time heavier, while still be able to address the dynamic forces, in order to provide the necessary vibration damping to a tolerable level.

However, the presence of offload springs 25 within active damping system 20 can also compromise isolation of dynamic forces that may affect payload 24. Specifically, since offload springs 25 may be positioned so the bottom end 252 of each offload spring 25 contacts ground 14, vibration or dynamic forces from ground 14 may get transferred through offload springs 25, to the intermediate mass 22, through the passive damper 23, and ultimately to the payload 24.

To minimize vibration or dynamic forces created by system components (i.e, base platform or ground 14) from being transferred to payload 24, active damping system 20 may incorporate a feedback compensation loop similar to compensation loop 191 in FIG. 1. Such a compensation loop, in one embodiment, includes a sensor 26. Sensor 26, as illustrated, may be positioned on the intermediate mass 22, and can act to provide a feedback signal be processed in order to obtain the motion or displacement exhibited by the intermediate mass 22. In particular, the feedback signal from sensor 26 may be communicated to a module, similar to module 192 in FIG. 1, which can integrate the signal to obtain the displacement and boosts gain. Module 192, in an embodiment, may be designed to apply a command signal to actuator 21, for example, sending variable voltage to the piezo actuator 21 in order to cause contraction and expansion accordingly.

Sensor 26, in one embodiment, may be a servo-accelerometer or any other vibration sensor, such as a geophone. Signal from the sensor 26, in an embodiment, may be proportional to the relative acceleration, or velocity, or position with respect to the “free floating” inertia mass inside or outside of the sensor. The sensor 26 and the related compensation circuits used in connection with the present invention may be similar to that disclosed in U.S. Pat. No. 5,823,307, which patent is hereby incorporated herein by reference.

The resulting feedback signal from sensor 26, may then be used to permit actuator 21 to sufficiently extend and contract, in response to dynamic forces from offload springs 25, as well as ground 14 or any other components of system 10, at a frequency that, when acting on the intermediate mass 22, would allow the intermediate mass 22 act as a stability point (i.e., vibration-free point). The intermediate mass 22, acting as a stability point, in an embodiment, can be used to dampen any dynamic forces and isolate such forces from being transferred to payload 24 by way of passive damper 23. In particular, since payload 24 may be support by passive damper 23, the position of passive damper 23 substantially directly on the intermediate mass 22 acting as a stability point can permit vibration and other dynamic forces from ground 14 or other components to be isolated from payload 24 and not get transferred to payload 24 via passive damper 23. For example, support spring 27, by design, may generate high level amplification at resonance frequency that can compromise the stability of the supported payload 24, passive damper 23 may act to direct such forces or any other slight dynamic forces acting on or from payload 24 to the intermediate mass 22, and thus the stability point. As a result, the payload 24 remains substantially free of vibration and other dynamic forces generated, for instance, by the floor or ground 14.

Support spring 27, as shown in FIG. 2A, may be positioned between payload 24 and intermediate mass 22 substantially in parallel and spaced relation from passive damper 23. Support spring 27, in one embodiment, may act to address static forces from payload 24 by supporting the weight of payload 24. In addition, support spring 27 can provide high frequency isolation above active frequency bandwidth. Specifically, since support spring 27 may be positioned substantially directly on the intermediate mass 22 acting as a stability point, vibration and other dynamic forces from ground 14 or other components may be isolated from payload 24, since such vibration can be dampened to the intermediate mass 22 and does not get transferred to payload 24 via support spring 27. As a result, the payload 24 remains substantially free of vibration and other dynamic forces generated, for instance, by the floor or ground 14. Furthermore, the presence of support spring 27 can act to maintain the payload 24 in substantial parallel relations to the intermediate mass 22. Although FIG. 2A illustrates only one support spring 27, it should be appreciated that additional support spring 27 may be used depending, for example, on the stiffness of support spring 27 relative to the mass of the payload 24. Accordingly, two or more support springs 27 may be used, so long as the payload 24 may be maintained in substantial parallel relations to the intermediate mass 22. Support spring 27, in an embodiment, may be about two orders of magnitude less in stiffness than that exhibited by the actuator, and may be a metallic spring, a coil spring, a die spring, a passive pneumatic spring, a pneumatic spring with active level control, or any other similar springs.

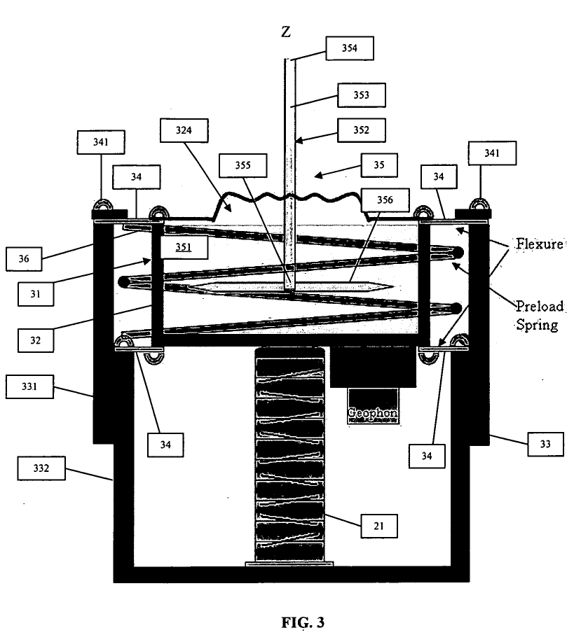

In accordance with another embodiment of the present invention, the passive damper and intermediate mass may be integral with one another, such that both the passive damper and the intermediate mass may be integrated substantially into a single unit. Looking now at FIG. 3, there is shown a single unit 30 incorporating an intermediate mass 31 and a passive damper 35. The intermediate mass 31, in one embodiment, may be positioned directly on top of actuator 31 and may be elastically decoupled from the payload 24. To secure the position of the intermediate mass 31 over the actuator 21 and to minimize lateral or radial movement of the intermediate mass 31, an external casing 33 may be provided, within which the actuator 21 and the intermediate mass 31 may be situated. In one embodiment, the casing 33 may include a upper portion 331 and a lower portion 332 capable of moving axially along the “Z” axis relatively to one another. A brace 34 may be provided along the interior of casing 33 and between which the intermediate mass 31 may be positioned to further minimize lateral or radial movement of the intermediate mass 31. Of course, any other mechanisms known in the art may be used minimize lateral or radial movement of the intermediate mass 31, for instance, providing an o-ring wedged between the intermediate mass 31 and the interior of the casing 33. In the embodiment shown in FIG. 3, the brace 34 may be secured to the casing 33 by fasteners 341, and the intermediate mass 31 may be secured between the brace 34 also by use of fasteners 341. The brace 34, in one embodiment, may be made from a flexible material to accommodate slight axial movement of the upper portion 331 relative to the lower portion 332 of the casing 33.

Still looking at FIG. 3, passive damper 35 may be interposed between the intermediate mass 31 and the isolated platform, and may be part of the intermediate mass 31. However, it should be noted that a separate passive damper can be provided independent of the intermediate mass, such as that shown in FIG. 2A. The provision of an intermediate mass 31 and passive damper 35 provides, as noted earlier, an actively isolated point (i.e., vibration-free point) to which dynamic forces may be dampened, and can further permit feedback gain at very high frequencies, since the passive damper 35 can provide passive vibration isolation at those high frequencies.

In the embodiment illustrated in FIG. 3, the passive damper 35 may be an elastic fluid damper and may include a volume of a viscous fluid 351, such as oil, silicon oil, or any other viscous fluid, within housing 32 defining the intermediate mass 31. The passive damper 35 may also include a piston 352 extending substantially vertically along axis Z into the viscous fluid within the housing 32. To accommodate the extension of the piston 352 into housing 32, an opening 324 may be provided. Piston 352, in one embodiment, includes a rod 353 having an external end 354 for placement against the isolated platform supporting the payload and an internal end 355 for placement within the volume of viscous fluid 351. Rod 353, in accordance with an embodiment, may be strong and rigid in the active axis, e.g., Z axis, and less rigid along the planes substantially perpendicular to the rod 353. The piston 352 further includes a widened surface, such as plate 356, at the internal end 355 of the rod 353. The plate 356, in the presence of vibration from the system 10, acts to permit the passive damper 35 to generate the necessary damping effect. The plate 356, in an embodiment, may be a solid plate. However, plate 356 may also be perforated to adjust the damping effect. Although described as a fluid damper, passive damper 35 may be any passive dampers known in the art.

As the piston 352 moves up and down within the housing 32 to generate the necessary damping effect, in order to minimize the occurrence of the piston 352 being dislodged from within the housing 32, the plate 356 may be made to have a width that may be measurably larger than the opening 324 of housing 32. Furthermore, to conserve potential loss of the viscous fluid 351 from within the housing 32 of the intermediate mass 31 during movement of the piston 352, a cover 326, such as a flexible membrane, may be positioned across the opening 324. When cover 326 is used, it may be necessary to create a hole (not shown) within the cover 326, so that the rod 353 of piston 352 may be accommodated therethrough. The hole, in one embodiment, may be sufficiently small, so as to create a substantially tight seal with the rod 353 of piston 352.

In an embodiment, a spring 36, which may be used to push actuator 21 into a preload compression state, may be situated circumferentially about housing 32. To retain the spring 36 about housing 32, the spring 36 may be positioned between brace 34 in a space between the intermediate mass 31 and the interior of the casing 33.

Although not shown, it should be appreciated that unit 30 may also include offload springs, similar to the offload springs 25 shown in FIGS. 2A-B. These offload springs, in an embodiment, may be situated between housing 32 of the intermediate mass 31 and the base of lower portion 332 of casing 33. In addition, these offload, as well as offload springs 25, may be utilized to lessen payload weight acting on any actuator. In particular, they may be used in connection with any mechanical, electronic, pneumatic, hydraulic or electromagnetic actuators, or any other actuators commercially available or known in the industry.

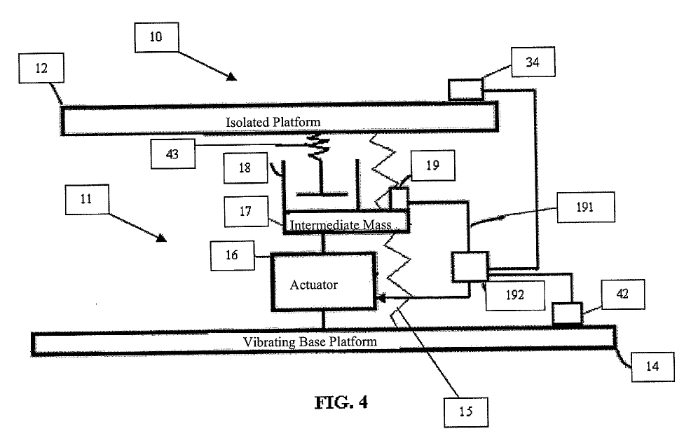

Referring now to FIG. 4, as noted previously, many of the supported payloads on isolated platform 12 involve moving mechanical components, which can generate forces that act on the payload and cause it to vibrate in response. Accordingly, it may be desirable to have the damping system 10 resist or minimize supported payload movement due to payload-induced forces. To do so, a second motion sensor 41 may be used in connection with the system 10. Sensor 41, which may be an absolute velocity sensor or a relative displacement sensor, may be mounted on the isolated platform 13. Signals from sensor 41 may be combined and integrated with signals from sensor 19 on the intermediate mass 17 to subsequently enhance vibration control of the isolated platform 13.

In a further embodiment, the system 10 may include a third motion sensor 42 mounted on the vibrating base platform 14 or floor. A signal from sensor 42 may be communicated to module 192, which then integrates the signal to obtain displacement and boosts gain. The resulting integrated signal may thereafter be processed by the module 192, which contains various compensation circuits, and used as a feed-forward signal to control the expansion and contraction of the actuator 16 to compensate for the vibrating base motion.

Still referring to FIG. 4, system 10 may also include a spring 43 attached, in series, at one end to isolated platform 12 and attached at an opposite end to passive damper 18. In this manner, spring 43, having a resonance frequency of at least one order of magnitude higher than that of supporting spring 44, may enhance vibration isolation gain to the system 10 at higher frequencies.

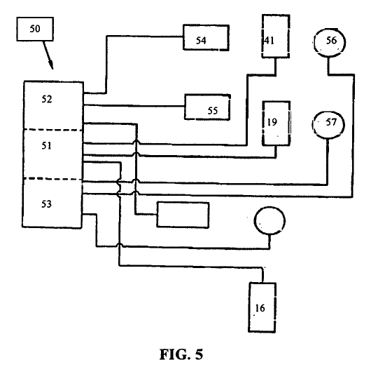

Although illustrated to actively isolate vibration along one axis, i.e., the “Z” axis, the intermediate mass and system of the present invention may be designed to actively isolate vibration along each of the “X”, “Y”, and “Z” axes. Looking now at FIG. 5, there is shown a high-level electrical schematic diagram illustrating the electrical interconnections between the motion sensors, compensation circuitry and actuators for a three-dimensional vibration damping system. An electronic controller indicated generally at 50 includes compensation circuits 51, 52 and 53. Each of these compensation circuits is similar to that disclosed in U.S. Pat. No. 5,823,304, which, as noted previously, is incorporated herein by reference.

Compensation/control circuit 51, in one embodiment, may be provided to receive sensor signals from the “Z” vertical payload sensor 41, which senses motion of the payload along the “Z” axis, and from the “Z” vertical intermediate mass sensor 19, which senses motion of the intermediate mass along the “Z” axis. Compensation/control circuit 52, on the other hand, receives sensor signals from a “Y” horizontal payload sensor 54, which senses motion of the payload along the “Y” axis, and from a “Y” intermediate mass sensor 55, which senses motion in the “Y” direction of the intermediate mass. As for compensation/control circuit 53, it receives signals from a “X” horizontal payload sensor 56 and a “X” direction intermediate mass sensor 57.

It should be appreciated that the compensation circuitry of the present invention may be implemented in analog or digital form. In addition, such compensation circuitry may be adapted to receive signals from the sensor situated on the vibrating base platform, such as sensor 32 in FIG. 3. Moreover, the compensation circuitry may be employed as a single module capable of receiving motion signals from each of six degrees of freedom and compensating for vibrations therealong. Alternatively, a plurality of compensation modules, for instance, six, may be used, with each provided for each of the six degrees of freedom.

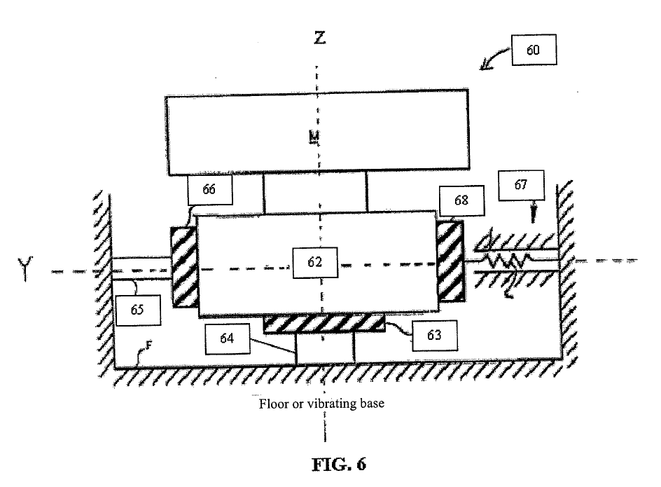

Looking now at FIG. 6, a simplified schematic diagram of an active vibration damping system 60 is illustrated in two dimensions. System 60 includes a supported payload M which rests on a passive damper 61, which in turn may be supported by an intermediate mass 62. A shear decoupler 63 may be interposed between the intermediate mass 62 and a vertical actuator 64. System 60 also provides active vibration isolation in a direction normal to the force exerted by the payload, i.e., along the “Y” axis. This isolation may be performed using a radial actuator 65, for instance, a piezoelectric motor, and a radial shear decoupler 66 situated between the actuator 65 and the intermediate mass 62. The radial actuator 65, in an embodiment, may be attached in some manner to the vibrating floor, external casing, base F. It should be appreciated that the axial stiffness of each shear decoupler may be maintained high, while the radial stiffness may be maintained relatively low, when the ratio of the loaded area to unloaded area is large. In an embodiment of the invention, the ratio of axial stiffness to radial stiffness of the shear decoupler may be at least one, and preferably two or more orders of magnitude.

As it is desirable that the intermediate mass 62 move along the “Z” axis, and not to rotate as the vertical actuator 64 extends and/or contract, shear decoupler 66 may be balanced on the other side of the intermediate mass 62 by shear decoupler 68 and spring element 67. Spring element 67, as shown in FIG. 6, may be disposed between a vibrating source, e.g., an extension of the floor, external casing, or vibrating base F, and shear decoupler 68, which in turn may be situated between the spring element 67 and the intermediate mass 62. The linear arrangement of radial actuator 65, shear decoupler 66, shear decoupler 68 and spring element 67 may be repeated in a direction normal to the paper, i.e., “X” axis, from the perspective of FIG. 6, to achieve vibration isolation in all three dimensions and along six degrees of freedom.

Spring element 67, in one embodiment, may be designed to have relatively low stiffness along the “Y” axis, and relatively high radial stiffness in all directions normal to the “Y” axis. In this manner, the spring element 67 may allow radial actuator 65 to contract or elongate readily according to the command signal applied to it. Moreover, the interposition of the decoupler 66 between the radial actuator 65 and the intermediate mass 62 can lower the shear deflection caused by, e.g., movement of payload-supporting vertical actuator 64, to about 0.7% of the movement of radial actuator 65, in one example.

In summary, an active vibration damping system has been shown and described. The vibration damping system, according to an embodiment of the invention, suppress and isolate dynamic forces generated from being transferred to the payload, while lessening the payload weight that acts on the actuator. Specifically, the system provides actively isolated damper interposed between the payload mass (i.e., isolated platform) and the vibrating source (i.e., base platform) to reduce the resonant frequency and necessary gain. The active damper may be designed to address dynamic vibration and includes at least one actuator, an intermediate mass supported by the actuator, and a passive damper between the intermediate mass and the isolated platform, and an offload spring in parallel to the actuator and positioned between the intermediate mass and the ground. The intermediate mass, in addition to being supported by the actuator vertically along the “Z” axis, may be supported radially by additional actuators along “X” and “Y” axes. The system also provides circuitry to drive the actuators as a function of displacement signals generated from sensors in the intermediate mass in the vertical direction or in each of the “X”, “Y”, and “Z” directions. In an embodiment, since offload at least one offload spring may be used, the actuator used in connection with the active damper of the present invention can be relatively smaller and less expensive than that used in a traditional vibration isolation system where the weight of the payload must also be supported by the actuator.

While the present invention has been described with reference to certain embodiments thereof, it should be understood by those skilled in the art that various changes may be made and equivalents may be substituted without departing from the true spirit and scope of the invention. In addition, many modifications may be made to adapt to a particular situation, indication, material and composition of matter, process step or steps, without departing from the spirit and scope of the present invention. All such modifications are intended to be within the scope of the claims appended hereto.

What is claimed is:

1. An active damping system for use in connection with a vibration isolation system, the active damper comprising:
an actuator, positioned on a floor or a base platform opposite a payload, for compensating dynamic forces acting on the vibration isolation system;
an intermediate mass, supported on the actuator assembly, for acting as a stability point to which dynamic forces can be dampened and isolated from the payload;
a passive damping element coupled at one end to the payload and at an opposite end to the intermediate mass acting as a stability point;
at least one offload spring situated between the intermediate mass and base platform to permit weight from the payload acting on the actuator to be transferred onto the offload spring; and
a sensor affixed to the intermediate mass to generate a signal, which is a function of movement of the intermediate mass, so feedback can be provided to the actuator for subsequent action on the intermediate mass to permit the intermediate mass to act as a stability point.

2. An active damping system as set forth in claim 1, wherein the actuator is one of a piezoelectric actuator, a mechanical actuator, a pneumatic actuator, a hydraulic actuator, an electromagnetic actuator, an amplified actuator, or any other actuators.

3. An active damping system as set forth in claim 1, wherein the intermediate mass is distinct and elastically decoupled from the payload.

4. An active damping system as set forth in claim 1, wherein the offload spring is situated adjacent the actuator.

5. An active damping system as set forth in claim 1, wherein the offload spring is situated circumferentially about the actuator.

6. An active damping system as set forth in claim 5, further including at least one offload spring situated adjacent the actuator.

7. An active damping system as set forth in claim 1, wherein the offload spring is less rigid or stiff relative to the actuating mechanism.

8. An active damping system as set forth in claim 1, wherein the offload spring can act to direct any dynamic forces from the base platform, ground, or any other components to the intermediate mass acting as a stability point, where such dynamic forces can be dampened, so as to isolate such dynamic forces from being transferred to the payload.

9. An active damping system as set forth in claim 1, wherein the sensor is one of a servo-accelerometer or a vibration sensor.

10. An active damping system as set forth in claim 1, further including a support spring situated in parallel to the passive damper between the payload and the intermediate mass for supporting the payload.

11. A system for isolating vibration from a supported payload, the system comprising:
an actuator positioned on a floor or a base platform opposite a payload;
an intermediate mass, supported on the actuator, for acting as a stability point to which dynamic forces can be dampened and isolated from the payload;
a passive damping element coupled at one end to the payload and at an opposite end about the intermediate mass acting as a stability point;
at least one offload spring situated between the intermediate mass and base platform to permit weight from the payload acting on the actuator to be transferred onto the offload spring;
a support spring situated in parallel to the passive damper between the payload and the intermediate mass for stabilizing the payload supported on the passive damper; and
a sensor affixed to the intermediate mass to generate a signal, which is a function of movement of the intermediate mass, so feedback can be provided to the actuator assembly for subsequent generation of the stability point on the intermediate mass.

12. A system as set forth in claim 11, wherein the actuator is one of a piezoelectric actuator, a mechanical actuator, a pneumatic actuator, a hydraulic actuator, an electromagnetic actuator, or any other actuators.

13. A system as set forth in claim 11, wherein the actuator is an amplified actuator capable of increase the stroke being applied to the payload.

14. A system as set forth in claim 11, wherein the intermediate mass is distinct and elastically decoupled from the payload mass.

15. A system as set forth in claim 11, wherein the offload spring is situated adjacent the actuator.

16. A system as set forth in claim 11, wherein the offload spring is situated circumferentially about the actuator.

17. A system as set forth in claim 11, wherein the offload spring can act to direct any dynamic forces from the base platform, ground, or any other components to the intermediate mass, where such dynamic forces can be dampened to the stability point thereon, so as to isolate such dynamic forces from being transferred to the payload.

18. A system as set forth in claim 11, wherein the offload spring is at least one order of magnitude less in stiffness than that exhibited by the actuator.

19. A system as set forth in claim 11, further including a compensation module having circuitry coupling the sensor to the actuator, so as to permit the actuator to extend and contract, based on the signal from the sensor, such that a stability point can be generated and maintained on the intermediate mass to stabilize the isolated platform over a predetermined range of vibration frequencies.

20. A system as set forth in claim 11, further including a motion sensor coupled to the base platform to generate a signal, which is a function of movement of the base platform, this sensor being in communication with the compensation module such that signals from this sensor can be used as feed-forward signals to compensate for vibration from the base platform.

21. A method for isolating vibration from a payload supported on an isolated platform, the method comprising:
positioning an actuator on the base platform in parallel to and spaced relation from the supporting spring;
placing on the actuator, an intermediate mass, so as to permit subsequent generation of a stability point on the intermediate to which vibration and other dynamic forces can be dampened and isolated from the payload;
situating at least one offload spring under the intermediate mass and on the base platform;
coupling one end of a passive damper to the isolated platform and an opposite end to an area where the stability point can be generated on the intermediate mass;
sensing movement of the intermediate mass resulting from dynamic forces being directed thereto by various components, and generating a feedback signal that is a function of the movement of the intermediate mass; and
permitting the actuator, based the feedback signal, to vary in length, so as to generate and maintain the stability point on the intermediate mass to which dynamic forces the can be dampened and isolated from the payload.

22. A method as set forth in claim 21, further including placing a support spring in parallel with the passive damper between the payload and the intermediate mass, so as to permit stabilizing of the payload supported on the passive damper.
